(19) United States
(12) Patent Application Publication
(10) Pub. No.: US 2023/0245196 A1
(43) Pub. Date: Aug. 3, 2023

(54) SYSTEMS AND METHODS FOR GENERATING A CONSIDERATION INTENT CLASSIFICATION FOR AN EVENT

(71) Applicant: Walmart Apollo, LLC, Bentonville, AR (US)

(72) Inventors: Spencer Galbraith, Bella Vista, AR (US); Parth Ramesh Vajge, Sunnyvale, CA (US); Sooraj Mangalath Subrahmannian, San Jose, CA (US); Divya Chaganti, San Jose, CA (US); Yue Xu, San Francisco, CA (US); Hyun Duk Cho, San Francisco, CA (US); Sushant Kumar, San Jose, CA (US); Kannan Achan, Saratoga, CA (US); Nimesh Sinha, San Jose, CA (US)

(21) Appl. No.: 17/587,659

(22) Filed: Jan. 28, 2022

(51) Int. Cl. G06Q 30/06; G06F 16/28

(52) U.S. Cl. CPC G06Q 30/0631; G06F 16/285

(57) ABSTRACT

A consideration intent system can include a computing device configured to receive an indication of an event occurring from a user device, obtain a set of parameters associated with the event and retrieve a set of item intent values corresponding to the set of items. The computing device is configured to determine a first value based on at least one parameter of the set of parameters and classify the event as one of: (i) low consideration intent and (ii) high consideration intent by inputting the set of item intent values and the first value as features to a machine learning algorithm. The computing device is configured to, based on the classification, identify a set of recommendation models, generate a set of recommended item identifiers by implementing at least one recommendation model of the set of recommendation models, and transmit the set of recommended item identifiers to the user device.

### TECHNICAL FIELD

The disclosure relates generally to systems and methods for generating consideration intent classifications and more particularly to determining a present consideration intent classification based on database entries.

### BACKGROUND

Customers shop for a variety of different items on ecommerce platforms. For example, customers can research and buy specific, expensive items as well as perform routine grocery shopping using different websites on their computers or applications on their mobile devices.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

The embodiments described herein are directed to a consideration intent system and related methods. The consideration intent system can include a computing device that is configured to receive an indication of an event occurring from a user device, obtain a set of parameters associated with the event. The set of parameters includes a set of items. The computing device is also configured to retrieve a set of item intent values corresponding to the set of items. The computing device is also configured to determine a first value based on at least one parameter of the set of parameters and classify the event as one of: (i) low consideration intent and (ii) high consideration intent by inputting the set of item intent values and the first value as features to a machine learning algorithm. The computing device is also configured to, based on the classification, identify a set of recommendation models, generate a set of recommended item identifiers by implementing at least one recommendation model of the set of recommendation models, and transmit the set of recommended item identifiers to the user device for display on a user interface.

In another aspect, the computing device is configured to obtain a user value corresponding to an account associated with a user of the user device and input the user value as a feature to the machine learning algorithm.

In another aspect, the set of parameters includes a location of the user device and a device type of the user device, and wherein the first value is determined based on the location of the user device and the device type of the user device.

In another aspect, the set of parameters includes, over a threshold period, item identifiers viewed on the user device, item identifiers added to a cart, and item identifiers purchased.

In another aspect, the computing device is configured to, for each item identifier included in the item identifiers viewed on the user device, the item identifiers added to the cart, and the item identifiers purchased, obtain a corresponding item value and input the corresponding item values as features to the machine learning algorithm.

In another aspect, the computing device is configured to, for each item identifier, in response to a threshold interval elapsing, obtain a set of data over a threshold period. In another aspect, the computing device is also configured to perform hyperparameter tuning for the set of data to determine the corresponding item value and store the corresponding item value in a database.

In another aspect, the computing device is configured to update the item identifiers viewed on the user device, the item identifiers added to the cart, and the item identifiers purchased in real time.

In another aspect, the set of parameters include search queries associated with an account of a user of the user device.

In various embodiments of the present disclosure, a method of consideration intents is provided. In some embodiments, the method can include receiving an indication of an event occurring from a user device and obtaining a set of parameters associated with the event. The set of parameters includes a set of items. The method includes retrieving a set of item intent values corresponding to the set of items, determining a first value based on at least one parameter of the set of parameters, and classifying the event as one of: (i) low consideration intent and (ii) high consideration intent by inputting the set of item intent values and the first value as features to a machine learning algorithm. The method also includes, based on the classification, identifying a set of recommendation models, generating a set of recommended item identifiers by implementing at least one recommendation model of the set of recommendation models, and transmitting the set of recommended item identifiers to the user device for display on a user interface.

In various embodiments of the present disclosure, a non-transitory computer readable medium is provided. The non-transitory computer readable medium can have instructions stored thereon, wherein the instructions, when executed by at least one processor, cause a device to perform operations that include receiving an indication of an event occurring from a user device and obtaining a set of parameters associated with the event. The set of parameters includes a set of items. The operations include retrieving a set of item intent values corresponding to the set of items, determining a first value based on at least one parameter of the set of parameters, and classifying the event as one of: (i) low consideration intent and (ii) high consideration intent by inputting the set of item intent values and the first value as features to a machine learning algorithm. The operations also include, based on the classification, identifying a set of recommendation models, generating a set of recommended item identifiers by implementing at least one recommendation model of the set of recommendation models, and transmitting the set of recommended item identifiers to the user device for display on a user interface.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The features and advantages of the present disclosures will be more fully disclosed in, or rendered obvious by, the following detailed descriptions of example embodiments. The detailed descriptions of the example embodiments are to be considered together with the accompanying drawings wherein like numbers refer to like parts and further wherein:

FIG. 1 is a block diagram of a consideration intent system in accordance with some embodiments;

FIG. 2 is a block diagram of a computing device implementing the consideration intent device of FIG. 1 in accordance with some embodiments;

FIG. 3 is a block diagram illustrating an example consideration intent module of the consideration intent system of FIG. 1 in accordance with some embodiments;

FIG. 4 is a block diagram illustrating an example score generation module of the consideration intent system of FIG. 1 in accordance with some embodiments;

FIG. 5 is a flowchart of example methods of generating an intent classification for an event in accordance with some embodiments; and

FIG. 6 is a flowchart of examples methods of generating user and item intent scores for storage in accordance with some embodiments.

In the drawings, reference numbers may be reused to identify similar and/or identical elements.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “connected,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

A consideration intent system may be implemented to classify a present shopping event according to the predicted intent of the shopping event. For example, the consideration intent system determines the intent of the shopping event based on a variety of factors including intent scores for items, the customer or user, and real time data occurring during the shopping event. For example, the consideration intent system may generate intent scores for each item as well as each user of an ecommerce platform. The classification of the shopping event in real time indicates whether the user is engaged in a low consideration event or a high consideration event.

A low consideration event typically indicates the user is most likely shopping for items that require little thought or research that tend to be affordable with low inter-purchase intervals, such as a routine grocery shopping trip. A high consideration event typically indicates the user is shopping for items that require more research and deliberate intent, including those items that tend to be more expensive and have a high inter-purchase interval, such as a new television. The consideration intent system determines, in real time, which type of shopping event corresponds to the user. The classification of the presently occurring shopping event may be used as input for a variety of recommendation systems and models to present to the user, on a user interface of the user device being used to shop, more relevant items, improving user experience and providing a more efficient shopping event for the user.

These intent scores may be based on historically collected data and may be a value between zero and one. For example, to determine an intent score for an item, the consideration intent system may obtain data including price of the item, inter-purchase interval of the item (how frequently the particular item is purchased), and a view to add to cart ratio (how frequently an item is viewed to how frequently the item is added to a cart). Other item data may also be included, such as total number of purchases, view to purchase ratio, how long a user is on the item page, etc. The consideration intent system determines a weighting for each factor to influence the item intent score using hyperparameter tuning to generate an optimal dataset that weights each factor properly for each item. For example, hyperparameter tuning may involve attempting a variety of different weights for the various parameters involved in determining the item intent score and selects the weightings that perform the best or most optimally on a downstream dataset. The item intent scores indicate under what circumstances the item is typically purchased, during a low consideration event or a high consideration event. In various implementations, if there is not enough data associated with an item to determine an intent score, for example, for new items, the consideration intent system may wait to generate an intent score until there is enough data. Alternatively, an average of the intent scores for a set of similar items may be used until enough data is collected.

Similarly, user intent scores are generated for each user of the ecommerce platform with an account using historical data such as item views, item add to carts, item purchases, etc., to determine an overall intent corresponding to that user. That is, the user intent score indicates what type of shopping event the user typically is engaged in, a low consideration event or a high consideration event. The user and item intent scores may be generated and updated at predetermined intervals, for example, monthly.

The consideration intent system receives real time data regarding a user's shopping event to classify the shopping event by incorporating the predetermined item and user intent scores. For example, the real time data may include items presently in a cart, recently viewed items, recent search queries, a zip code of the location of the user device being used to shop, a device type of the user device, etc. From the items recently viewed, added to cart, and that correspond to the search queries, the consideration intent system may obtain the corresponding item intent scores indicating the type of shopping event. Additionally, the consideration intent system may obtain the user intent score if the user is logged in to the ecommerce platform while the shopping event is occurring. However, even if the user is not logged in, the consideration intent system receives a device type and a zip code where the user device is located that the user is using the shop. From the location and the device type, the consideration intent system can infer a likely type of shopping event. For example, if the device type is a computer, it may be more likely that the shopping event is high consideration versus the device type being a mobile computing device. Further, if a location of a store corresponding to the ecommerce platform is greater than a certain distance from the zip code of the user device, the shopping event may be more likely to be a high consideration event since the user is searching outside of local stores.

The collected scores and real time information, which is continuously updated based on user activity, is used in an unsupervised machine learning algorithm, for example, a clustering algorithm, to classify the shopping event as high consideration or low consideration. The classification may be forwarded to a system or module that selects a particular set of recommendation modules to generate recommended items for display on the user device based on the type of shopping event. In various implementations, the consideration intent system may also predict an intent of a next shopping event for a user.

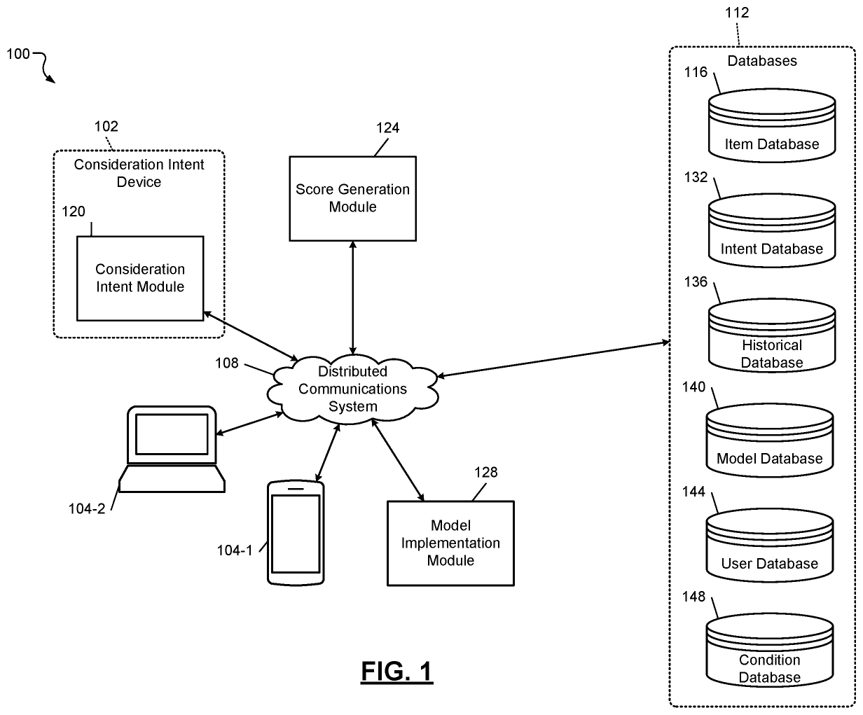

Referring to FIG. 1, a block diagram of a consideration intent system 100 is shown. The consideration intent system 100 may include a consideration intent device 102 and user devices 104-1 and 104-2, collectively user device 104, such as a phone, tablet, laptop, mobile computing device, desktop, etc., capable of communicating with a plurality of databases 112 and modules via a distributed communications system 108. The user device 104 may display an ecommerce marketplace via a web browser or an application for customers to view items for sale by the ecommerce marketplace that are stored in an item database 116. For example, a customer may browse a webpage being display on a graphical user interface of the user device 104 and/or submit a query through the graphical user interface of the user device 104 on the ecommerce marketplace through a web browser or application, which retrieves a subset of items from the item database 116 that pertain to the query and displays the subset of items to the customer via the graphical user interface of the user device 104.

The consideration intent system 100 also includes a consideration intent module 120, a score generation module 124, and a model implementation module 128. The consideration intent module 120 obtains user and item intent scores from an intent database 132 along with real time data directly from the user device 104 the user is using to shop in order to classify the shopping event in real time. The classification along with the selections made during the shopping event may be stored in a historical database 136 for the consideration intent system 100 to incorporate into user and item intent scores. The classification may also be forwarded to the model implementation module 128 that identifies a plurality of models stored in a model database 140 to implement and generated recommended items for display on the user device 104.

The score generation module 124 may be implemented at predetermined intervals, for example, monthly, to generate an intent score for each user and each item. The generated intent scores may be stored in the intent database 132. The scores may be generated based on data stored in the item database 116 for the item intent scores and a user database 144 for the user intent scores. Additionally, the consideration intent system 100 may include a condition database 148 that stores predetermined intent classifications for different device types and zip codes. These intent classifications may be updated based on an overall intent classification of the respective cohorts over a predetermined period. That is, if a particular region leans toward high consideration shopping, the intent for that zip code may reflect the high consideration tendencies.

The consideration intent device 102 and the user device 104 can be any suitable computing device that includes any hardware or hardware and software combination for processing and handling information. For example, the term “device” and/or “module” can include one or more processors, one or more field-programmable gate arrays (FPGAs), one or more application-specific integrated circuits (ASICs), one or more state machines, digital circuitry, or any other suitable circuitry. In addition, each can transmit data to, and receive data from, the distributed communications system 108. In various implementations, the devices, modules, and databases may communicate directly on an internal network.

As indicated above, the consideration intent device 102 and/or the user device 104 can be a computer, a workstation, a laptop, a server such as a cloud-based server, or any other suitable device. In some examples, consideration intent device 102 and/or the user device 104 can be a cellular phone, a smart phone, a tablet, a personal assistant device, a voice assistant device, a digital assistant, a laptop, a computer, or any other suitable device. In various implementations, the consideration intent device 102 is on a central computing system that is operated and/or controlled by a retailer. Additionally or alternatively, the modules and databases of the consideration intent device 102 are distributed among one or more workstations or servers that are coupled together over the distributed communications system 108.

The databases described can be remote storage devices, such as a cloud-based server, a memory device on another application server, a networked computer, or any other suitable remote storage. Further, in some examples, the databases can be a local storage device, such as a hard drive, a non-volatile memory, or a USB stick.

The distributed communications system 108 can be a WiFi network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The distributed communications system 108 can provide access to, for example, the Internet.

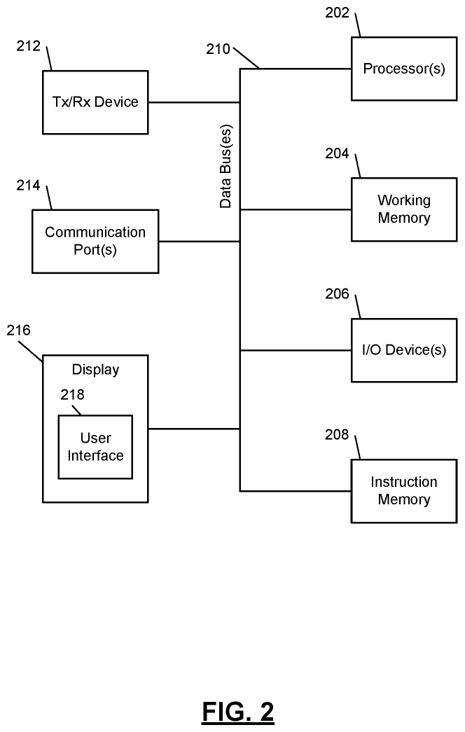

FIG. 2 illustrates an example computing device 200. The consideration intent device 102 and/or the user device 104 may include the features shown in FIG. 2. For the sake of brevity, FIG. 2 is described relative to the consideration intent device 102.

As shown, the consideration intent device 102 can be a computing device 200 that may include one or more processors 202, working memory 204, one or more input/output devices 206, instruction memory 208, a transceiver 212, one or more communication ports 214, and a display 216, all operatively coupled to one or more data buses 210. Data buses 210 allow for communication among the various devices. Data buses 210 can include wired, or wireless, communication channels.

Processors 202 can include one or more distinct processors, each having one or more cores. Each of the distinct processors can have the same or different structure. Processors 202 can include one or more central processing units (CPUs), one or more graphics processing units (GPUs), application specific integrated circuits (ASICs), digital signal processors (DSPs), and the like.

Processors 202 can be configured to perform a certain function or operation by executing code, stored on instruction memory 208, embodying the function or operation. For example, processors 202 can be configured to perform one or more of any function, method, or operation disclosed herein.

Instruction memory 208 can store instructions that can be accessed (e.g., read) and executed by processors 202. For example, instruction memory 208 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 202 can store data to, and read data from, working memory 204. For example, processors 202 can store a working set of instructions to working memory 204, such as instructions loaded from instruction memory 208. Processors 202 can also use working memory 204 to store dynamic data created during the operation of the consideration intent device 102. Working memory 204 can be a random access memory (RAM) such as a static random access memory (SRAM) or dynamic random access memory (DRAM), or any other suitable memory.

Input-output devices 206 can include any suitable device that allows for data input or output. For example, input-output devices 206 can include one or more of a keyboard, a touchpad, a mouse, a stylus, a touchscreen, a physical button, a speaker, a microphone, or any other suitable input or output device.

Communication port(s) 214 can include, for example, a serial port such as a universal asynchronous receiver/transmitter (UART) connection, a Universal Serial Bus (USB) connection, or any other suitable communication port or connection. In some examples, communication port(s) 214 allows for the programming of executable instructions in instruction memory 208. In some examples, communication port(s) 214 allow for the transfer (e.g., uploading or downloading) of data, such as data items including feedback information.

Display 216 can display a user interface 218. User interfaces 218 can enable user interaction with the consideration intent device 102. For example, user interface 218 can be a user interface that allows an operator to select and browse items via the ecommerce website or marketplace. The user interface 218 can, for example, display the items for sale for a user or customer view as a result of searching or browsing on an ecommerce marketplace. In some examples, display 216 can be a touchscreen, where user interface 218 is displayed on the touchscreen.

Transceiver 212 allows for communication with a network, such as the distributed communications system 108 of FIG. 1. For example, if the distributed communications system 108 of FIG. 1 is a cellular network, transceiver 212 is configured to allow communications with the cellular network. In some examples, transceiver 212 is selected based on the type of distributed communications system 108 in which the consideration intent device 102 will be operating. Processor(s) 202 is operable to receive data from, or send data to, a network, such as the distributed communications system 108 of FIG. 1, via transceiver 212.

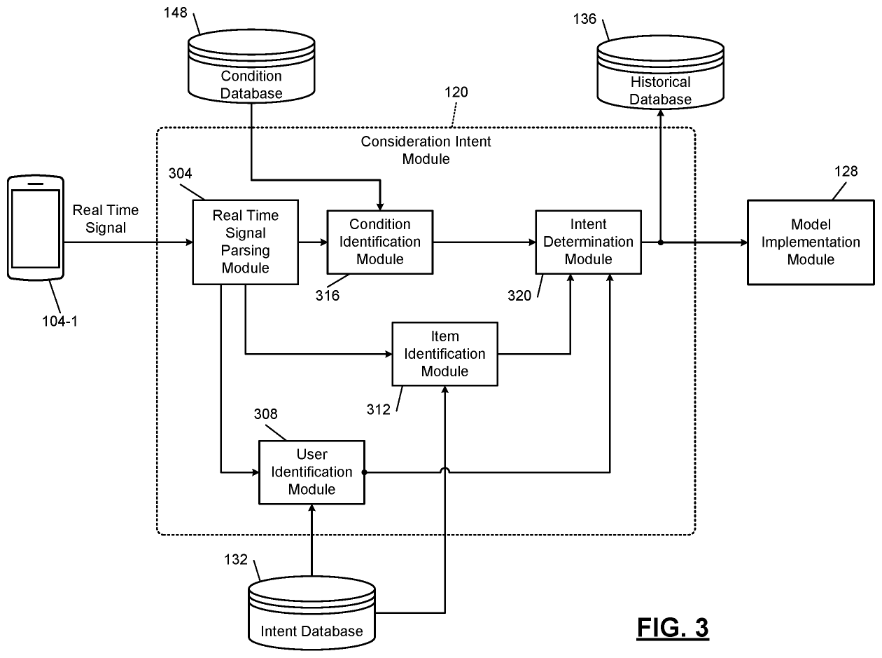

Referring now to FIG. 3, a block diagram illustrating an example consideration intent module of the consideration intent system 100 is shown. The consideration intent module 120 includes a real time signal parsing module 304 that receives real time signals from the user device 104 that is being used to conduct a shopping event. These signals include recent search queries, items viewed, items added to cart, zip code of the user device 104, device type of the user device 104, user identifier, etc. The real time signal parsing module 304 forwards signals related to the user, such as the user identifier, to a user identification module 308, signals related to the item, such as items viewed, to an item identification module 312, and signals related to a shopping condition, such as the zip code and device type, to a condition identification module 316.

The user identification module 308 obtains a user intent score from the intent database 132 if the user identifier corresponds to a user with an intent score. For example, if the user is logged in to the ecommerce platform and has had an account long enough for the consideration intent system 100 to generate a corresponding intent score for the user. Otherwise, if the user is not logged in or does not have a score, the user identifier would not be included in the intent database 132 as corresponding to any score. The user intent score or the lack thereof is forwarded to an intent determination module 320 for combination with other intent scores as input into a machine learning algorithm, such as a clustering algorithm to categorize the present shopping event as high or low consideration.

The item identification module 312 receives the signals identifying items, including items that are considered relevant to particular search queries. The item identification module 312 determines the items that are indicated in the real time signals and obtains the corresponding intent scores from the intent database 132. In various implementations, if the item does not correspond to an item intent score, the item is simply excluded from the classification determination made by the intent determination module 320. The item intent scores are forwarded to the intent determination module 320. The condition identification module 316 obtains intents stored in the condition database 148 that correspond to the zip code and/or the device type. Those intents, which also may be scores, are forwarded to the intent determination module 320. As mentioned previously, the intent determination module 320 implements a clustering algorithm to classify the shopping event as low or high consideration. The classification is stored in the historical database 136 and is forwarded to the model implementation module 128, which identifies and implements models to recommend items to the user via the user device 104 during the shopping event.

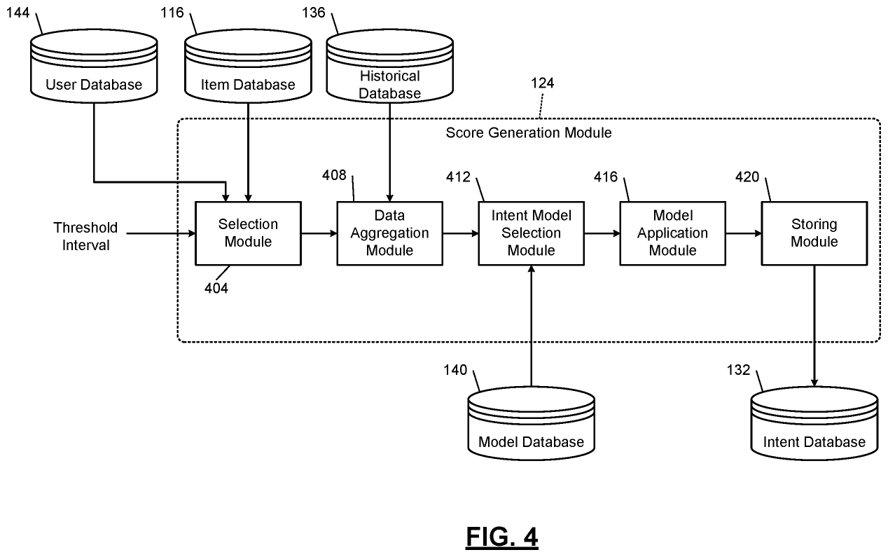

Referring now to FIG. 4, a block diagram illustrating an example score generation module 124 of the consideration intent system 100 is shown. The score generation module 124 generates an intent score for items as well as users at predetermined threshold intervals, for example, monthly. The score generation module 124 includes a selection module 404 that receives a prompt at the threshold interval. In various implementations, the prompt may indicate to the selection module 404 to generate an intent score for each user in the user database 144 and each item in the item database 116. In some embodiments, the selection module 404 receives specific users or items in the prompt that the selection module 404 is instructed to select for score generation.

The selection module 404 selects the users and/or items from the corresponding database to generate intent scores. The selected user and item identifiers are forwarded to a data aggregation module 408. The data aggregation module 408 obtains data corresponding to the selected users and items from the historical database 136. For example, for a selected user, the data aggregation module 408 obtains data including which items the user has viewed, added to their cart, purchased, etc., over a previous period, for example, over the last three months. For a selected item, the data aggregation module 408 may obtain data including item price, inter-purchase interval, view to add to cart ratio, amount of time spent viewing an item, etc., over a previous period, such as the last three months. The aggregated data for the users and items is forwarded to an intent model selection module 412.

The intent model selection module 412 selects a model from the model database 140 to determine an intent score of the user and/or item. Different models may be used for users and items. As noted previously, the selected model may be configured to implement hyperparameter tuning to generate an optimal dataset by assigning different weights to the aggregated data and identifying which weightings are the best, which determines how much each parameter influences the intent score for the user or item. The intent score indicates whether the user and/or item indicates a low consideration shopping event or a high consideration shopping event. The selected model is forwarded to a model application module 416 to implement the hyperparameter tuning for the user/item to determine the corresponding intent score. The determined intent score is forwarded to a storing module 420 that stores the intent scores in the intent database 132 as corresponding to the particular user or item.

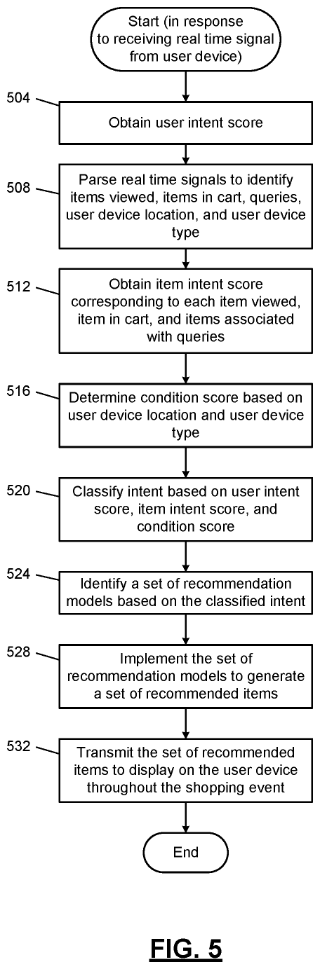

Referring now to FIG. 5, a flowchart of example methods of generating an intent classification for an event is shown. Control begins in response to receiving a real time signal from a user device. The real time signals from the user device correspond to a particular shopping event of the user. Control continues to 504 to obtain a user intent score for the user corresponding to the user device. For example, if the user is logged in to an account on a webpage or through an application, the consideration intent system can identify the user corresponding to the account and obtain the corresponding user intent score. If the user is not logged in or does not have a user intent score stored in the consideration intent system, a user intent score is simply excluded from the consideration intent determination. Control continues to 508 to parse the received real time signals to identify items recently viewed during the particular shopping event, items in the cart, recent queries submitted by the user, user device location, and user device type. Control receives real time signals throughout the shopping event and updates the intent determination accordingly. For example, each selection the user makes on the user device is received to update which items the user is viewing, what the user is searching, etc.

Control proceeds to 512 to obtain the item intent scores corresponding to each item viewed, items in the cart, and items associated with any recent queries. Control continues to 516 to determine a condition score based on the user device location and the user device type. As mentioned previously, the user device location may be a zip code and the condition score may correspond to whether the particular zip code is generally low consideration intent or high consideration intent based on factors such as whether the zip code has a store associated with the ecommerce platform. That is, the condition score may indicate the shopping event is more likely to be high consideration if the zip code does not have the store. Additionally the condition score may be influenced based on whether the user device is a mobile device or a computer, such as a desktop. That is, a shopping event on a mobile device may be more likely to be low consideration while a shopping event on a computer may be more likely to be a high consideration event.

Control continues to 520 to classify intent based on the user intent score, the item intent scores, and the condition score using a machine learning algorithm, such as a clustering algorithm. Control proceeds to 524 to identify a set of recommendation models based on the classified intent. At 528, control implements the set of recommendation models to generate a set of recommended items. Control continues to 532 to transmit the set of recommended items to display on the user device throughout the shopping event. Then, control ends.

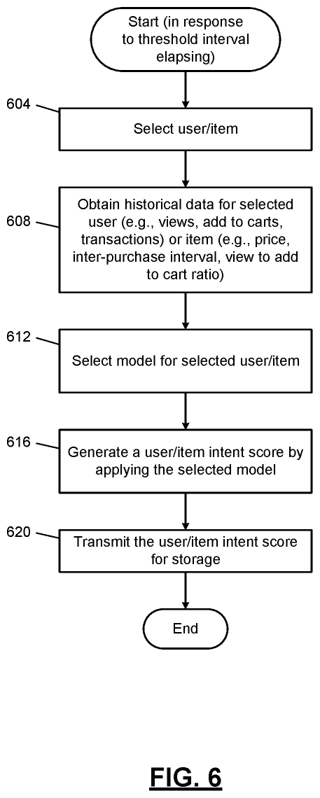

Referring now to FIG. 6, a flowchart of examples methods of generating user and item intent scores for storage is shown. Control begins in response to a threshold interval elapsing, for example, one month. Control continues to 604 to select a user or item for which to generate a score. Control proceeds to 608 to obtain historical data for the selected user (for example, views, add to carts, transactions, etc.) or the selected item (for example, price, inter-purchase interval, view to add to cart ratio, etc.). Control proceeds to 612 to select a model for the selected user or item. Control continues to 616 to generate a user or item intent score by applying the selected model. As noted previously, the model may implement hyperparameter tuning to optimally weight all the features of the score. Control proceeds to 620 to transmit the user or item intent score for storage in, for example, a database. Then, control ends.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The term model as used in the present disclosure includes data models created using machine learning. Machine learning may involve training a model in a supervised or unsupervised setting. Machine learning can include models that may be trained to learn relationships between various groups of data. Machine learned models may be based on a set of algorithms that are designed to model abstractions in data by using a number of processing layers. The processing layers may be made up of non-linear transformations. The models may include, for example, artificial intelligence, neural networks, deep convolutional and recurrent neural networks. Such neural networks may be made of up of levels of trainable filters, transformations, projections, hashing, pooling and regularization. The models may be used in large-scale relationship-recognition tasks. The models can be created by using various open-source and proprietary machine learning tools known to those of ordinary skill in the art.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
a computing device configured to:
receive an indication of an event occurring from a user device;
obtain a set of parameters associated with the event, the set of parameters including a set of items;
retrieve a set of item intent values corresponding to the set of items;
determine a first value based on at least one parameter of the set of parameters;
classify the event as one of: (i) low consideration intent and (ii) high consideration intent by inputting the set of item intent values and the first value as features to a machine learning algorithm;
based on the classification, identify a set of recommendation models;
generate a set of recommended item identifiers by implementing at least one recommendation model of the set of recommendation models; and
transmit the set of recommended item identifiers to the user device for display on a user interface.

2. The system of claim 1, wherein the computing device is configured to:
obtain a user value corresponding to an account associated with a user of the user device; and
input the user value as a feature to the machine learning algorithm.

3. The system of claim 1, wherein the set of parameters includes a location of the user device and a device type of the user device, and wherein the first value is determined based on the location of the user device and the device type of the user device.

4. The system of claim 1, wherein the set of parameters includes, over a threshold period, item identifiers viewed on the user device, item identifiers added to a cart, and item identifiers purchased.

5. The system of claim 4, wherein the computing device is configured to:
for each item identifier included in the item identifiers viewed on the user device, the item identifiers added to the cart, and the item identifiers purchased, obtain a corresponding item value; and
input the corresponding item values as features to the machine learning algorithm.

6. The system of claim 5, wherein the computing device is configured to, for each item identifier:
in response to a threshold interval elapsing, obtain a set of data over the threshold period;
perform hyperparameter tuning for the set of data to determine the corresponding item value; and
store the corresponding item value in a database.

7. The system of claim 5, wherein the computing device is configured to update the item identifiers viewed on the user device, the item identifiers added to the cart, and the item identifiers purchased in real time.

8. The system of claim 1, wherein the set of parameters include search queries associated with an account of a user of the user device.

9. A method comprising:
receiving an indication of an event occurring from a user device;
obtaining a set of parameters associated with the event, the set of parameters including a set of items;
retrieving a set of item intent values corresponding to the set of items;
determining a first value based on at least one parameter of the set of parameters;
classifying the event as one of: (i) low consideration intent and (ii) high consideration intent by inputting the set of item intent values and the first value as features to a machine learning algorithm;
based on the classification, identifying a set of recommendation models;
generating a set of recommended item identifiers by implementing at least one recommendation model of the set of recommendation models; and
transmitting the set of recommended item identifiers to the user device for display on a user interface.

10. The method of claim 9, further comprising:
obtaining a user value corresponding to an account associated with a user of the user device; and
inputting the user value as a feature to the machine learning algorithm.

11. The method of claim 9, wherein the set of parameters includes a location of the user device and a device type of the user device, and wherein the first value is determined based on the location of the user device and the device type of the user device.

12. The method of claim 9, wherein the set of parameters includes, over a threshold period, item identifiers viewed on the user device, item identifiers added to a cart, and item identifiers purchased.

13. The method of claim 12, further comprising:
for each item identifier included in the item identifiers viewed on the user device, the item identifiers added to the cart, and the item identifiers purchased, obtaining a corresponding item value; and
inputting the corresponding item values as features to the machine learning algorithm.

14. The method of claim 13, further comprising:
in response to a threshold interval elapsing, obtaining a set of data over the threshold period;
performing hyperparameter tuning for the set of data to determine the corresponding item value; and
storing the corresponding item value in a database.

15. The method of claim 13, further comprising updating the item identifiers viewed on the user device, the item identifiers added to the cart, and the item identifiers purchased in real time.

16. The method of claim 9, wherein the set of parameters include search queries associated with an account of a user of the user device.

17. A non-transitory computer readable medium having instructions stored thereon, wherein the instructions, when executed by at least one processor, cause a device to perform operations comprising:
receiving an indication of an event occurring from a user device;
obtaining a set of parameters associated with the event, the set of parameters including a set of items;
retrieving a set of item intent values corresponding to the set of items;
determining a first value based on at least one parameter of the set of parameters;
classifying the event as one of: (i) low consideration intent and (ii) high consideration intent by inputting the set of item intent values and the first value as features to a machine learning algorithm;
based on the classification, identifying a set of recommendation models;
generating a set of recommended item identifiers by implementing at least one recommendation model of the set of recommendation models; and
transmitting the set of recommended item identifiers to the user device for display on a user interface.

18. The non-transitory computer-readable medium of claim 17, further comprising:
obtaining a user value corresponding to an account associated with a user of the user device; and
inputting the user value as a feature to the machine learning algorithm.

19. The non-transitory computer-readable medium of claim 17, wherein the set of parameters includes a location of the user device and a device type of the user device, and wherein the first value is determined based on the location of the user device and the device type of the user device.

20. The non-transitory computer-readable medium of claim 17, wherein the set of parameters includes, over a threshold period, item identifiers viewed on the user device, item identifiers added to a cart, and item identifiers purchased.
